(19) United States
(12) Patent Application Publication
(10) Pub. No.: US 2006/0083237 A1
(43) Pub. Date: Apr. 20, 2006

(54) Communication apparatus and communication method

(75) Inventors: Yoshifumi Sakata, Kasuga-shi (JP); Satoshi Ando, Fukutsu-shi (JP); Yuji Shimizu, Koga-shi (JP); Mikio Shimazu, Kasuya-gun (JP); Yuichi Kawaguchi, Kasuya-gun (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/245,447

(22) Filed: Oct. 7, 2005

(30) Foreign Application Priority Data
Oct. 8, 2004 (JP) 2004-295942

(51) Int. Cl. H04L 12/56; H04L 12/28

(52) U.S. Cl. 370/389

(57) ABSTRACT

By transmitting such an extended Echo request packet that device setting information was written in a payload of an ICMP-Echo packet, to an terminal 10b equipped with ICMP function which does not has a special function, the extended Echo request packet collect device setting statuses of relay devices 110 equipped with extended Echo, and an extended Echo reply packet, which is a reply packet in which a payload of the extended Echo request packet was copied, conveys the compiled device setting statuses and device setting information to each device on a communication route, and thereby, it is possible to carry out a uniform device setting.

### BACKGROUND OF THE INVENTION

1. Field of the Invention

This invention relates to a communication apparatus and a communication method including a relay device which carries out a setting regarding a network.

2. Description of the related art

As one of features of a network through the use of TCP/IP (Transmission Control Protocol/Internet Protocol), there is route control on the basis of an IP address.

This is such a mechanism that a packet relay device called as a router selects a relay device to which a packet should be sent next, from a destination IP address included in the packet, and transfer of a packet is repeated between relay devices, and thereby, a packet is finally sent along to a terminal of a destination.

By this route control, even if a terminal does not know a route with respect to each terminal of a communication partner, and if it is possible to request at least one router for a relay of a packet, it becomes possible to communicate with a number of terminals through this router.

In Internet of a best-effort system, packet disposal occurs when a network is congested. Even if the packet disposal occurs on the occasion of browsing home pages, it simply takes time for browsing home pages and it does not becomes a big problem to a user, but in case that the packet disposal occurred in real-time communication such as Internet telephone etc. which have been increased rapidly in recent years, there is a problem of deterioration of communication quality, in which sound is broken up and telephone call becomes impossible, etc.

In order to guarantee the above-described communication quality, there is a technology called as Quality of service (QOS) for carrying out such control that, in order for a packet in real-time communication not to be disposed and delayed, a band width on a communication route is guaranteed in a relay device, and it prevails over another data flow.

QoS is an effective technology for assuring communication quality, but a setting for controlling a band width etc. has to be carried out from a terminal which knows characteristic of a data flow of real-time communication to a relay device on a communication route.

As a method of instructing communication quality to a relay device on a communication route between terminals, there is RSVP (Resource Reservation Protocol), which was ruled by IETF (Internet Engineering Task Force)which is a standardization organization.

In addition, although it is not a method of instructing communication quality to a relay device on a communication route between terminals, as means to know a relay device which is located on a communication route to a communication partner, there is a method using an Echo message, an Echo-Reply message, a Time-Exceeded message and so on of ICMP. (RFC1122 Requirements for Internet Hosts) is a rule regarding functions of a communication apparatus.

In the (RFC1122 Requirements for Internet Hosts), it is ruled that a communication apparatus has a function of ICMP (Internet Control Message Protocol) etc., in addition to IP. (RFC792 Internet Control Message Protocol) is a rule regarding ICMP.

FIG. 16 shows a view which shows a payload format of ICMP.

In ICMP, there are a plurality of types, and FIG. 16 shows formats of an Echo message, an Echo-Reply message, and a Time-Exceeded message which relate to the invention.

(a) of FIG. 16 shows an example of a format of the Echo message, and (b) of FIG. 16 shows an example of a format of the Echo-Reply message, and (c) of FIG. 16 shows an example of a format of the Time-Exceeded message.

In the (RFC792 Internet Control Message Protocol), it is ruled that a communication apparatus, which received an Echo message, has to transmit an Echo-Reply message.

Meanwhile, there is no particular rule as to a payload of Echo, and it is allowed to write arbitrary data therein.

FIG. 17 shows a view which shows a flow of processing of communication by use of an Echo message and an Echo-Reply message.

In FIG. 17, 10 designates a conventional communication apparatus which has an ICMP function, and 11 designates a bridge which is a relay device in an IP lower layer.

An echo message, which a terminal 10a transmitted by designating a terminal 10b as a destination, is relayed by bridges 11a, 11b, and 11c, and reaches to 10b which is a destination terminal.

The terminal 10b, which received the Echo message, copies a payload of the received Echo message to a payload of an Echo-Reply message, and transmits it to the terminal 10b which is a transmission source of the Echo message.

In a relay device, there are a router which relays a massage in an IP layer, and a bridge which relays a message in a lower layer of IP, such as IEEE802.3 and IEEE802.11. (RFC1812 Requirements for IP Version 4 Routers) is a rule regarding functions of a router.

In the (RFC1812 Requirements for IP Version 4 Routers), it is ruled that a router has to transmit a Time-Exceeded message in which an entirety of the received IP packet was copied to a payload, to an IP packet in which TTL (Time-To-Live) became 0.

FIG. 18 shows a view which shows a flow of processing of a communication by use of the Echo message and the Time-Exceeded message.

In FIG. 18, 12 designates a router which is a relay device in an IP layer, and 10, 11 are the same as in FIG. 17.

The terminal 10a transmits an Echo message in which TTL is 1, to the terminal 10b as a destination.

This Echo message is relayed by the bridge 11a, and thereafter, reaches to the router 12. The router 12 copies the received Echo message to a payload of a Time-Exceeded message, and transmits it to the terminal 10a as a destination, since TTL becomes 0 as a consequence of subtracting 1 from TTL of a received IP packet.

The Time-Exceeded message is relayed by the bridge 11a, and reaches to the terminal 10a.

On one hand, as a system of carry out a setting to a conventional network device, there is (RFC2205 Resource ReServation Protocol (RSVP)).

RSVP, which was cited in the (RFC2205 Resource ReServation Protocol (RSVP)), is a system of applying a setting to a relay device on a communication route, in order to carry out Quality of Service (QoS) of a data flow between transmission and reception terminals.

The above-described function regarding ICMP is essential to a communication apparatus and a router, whereas RSVP is not an essential function for a communication apparatus and a router. There fore, since a communication apparatus of a communication partner and a router on a communication route are not necessarily equipping to RSVP, it is not necessarily possible to carry out a setting of QoS by RSVP.

FIG. 19 shows a view which shows an example (setting successful example) of a device setting system using RSVP.

In FIG. 19, 20 designates a terminal equipped with RSVP, and 21 designates a relay device equipped with RSVP. 10 is the same terminal as in FIG. 17.

A device setting system using RSVP is composed of the terminal 20 equipped with RSVP which transmits and receive data and the relay device 21 equipped with the RSVP which is device-setup by RSVP.

By use of FIG. 19, a flow of processing in case of carrying out a setting of QoS regarding a data flow between terminals 20a and 20b equipped with RSVP will be described.

In order to simplify subsequent explanations, it is defined that the RSVP corresponding terminal 20a side is called as a upper stream, and the RSVP corresponding terminal 20b side is called as a lower stream, from a view point of a device as an object to be explained.

The terminal 20a equipped with RSVP transmits a Path message in which data flow setting information is written, to the terminal 20b equipped with RSVP as a destination.

The Path message, which was transmitted by the RSVP corresponding terminal 20a, is sequentially relayed by relay devices 21a, 21b and 21c equipped with RSVP, which are located on a route to a destination, and thereafter, reaches to the terminal 20b equipped with RSVP which is a destination.

Hereinafter, processing in each relay device will be described.

Firstly, in the relay device 21a equipped with RSVP which relays the Path message, it reads out the setting information, and carries out processing on the basis of the setting information, and writes its processing result in the Path message, and transmits it toward the RSVP corresponding terminal 20b which is a destination.

Next, in the relay device 21b equipped with RSVP which relays the Path message, it reads out the setting information and a processing result of the upper stream relay device 21a equipped with RSVP, and carries out processing on the basis of the setting information and the processing result of the upper stream relay device, and writes its processing result in the Path message, and transmits it toward the terminal 20b equipped with RSVP which is a destination.

Next, in the relay device 21c equipped with RSVP which relays the Path message, it reads out the setting information and the processing results of the upper stream relay device 21a equipped with RSVP and relay device 21b equipped with RSVP, and carries out processing on the basis of the setting information and the upper stream processing results, and adds its processing result to the Path message, and transmits it toward the terminal 20b equipped with RSVP which is a destination.

By the above-described procedures, the setting information and the processing result of the upper stream relay device 21 are notified to the lower stream relay device 21 and a reception terminal.

In the terminal 20b equipped with RSVP which is a destination of the Path message, when it receives the Path message, it reads out the setting information and the processing results of the upper stream relay devices 21a, 21b, and 21c equipped with RSVP and carries out processing on the basis of the setting information and the processing results, and prepares a Resv message on the basis of information in the Path message, and transmits it toward the terminal 20a equipped with RSVP which is a transmission source of the Path message.

The Resv message, which was transmitted by the RSVP corresponding terminal 20b, is sequentially relayed by the relay devices 21c, 21b, and 21a equipped with RSVP on the same route of the Path message in a reverse direction, and thereafter, reaches to the terminal 20a equipped with RSVP which is a destination.

By this Resv message, lower stream side information is notified to a upper stream side device.

In RSVP, it is possible to notify information from a upper stream to a lower stream by the Path message, and notify information from a lower stream to a upper stream by the Resv message which is a reply of the Path message.

RSVP requires that both of transmission and reception terminals equip to RSVP.

In sum, even if a relay device on a communication route equips to RSVP, there is such a problem that it is not possible to carry out a setting of a relay device on a route, only if either one of transmission and reception terminals does not correspond to RSVP.

By use of FIG. 20, a problem of prior art will be described.

In FIG. 20, since a configuration is the same as in FIG. 19, an explanation will be omitted.

In FIG. 20, it is assumed that a Path message is transmitted from the terminal 20a equipped with RSVP to the terminal 10b not equipped with a RSVP.

The relay device 21 RSVP on a route notifies information from an upper stream to a lower stream in the same manner as in the case of FIG. 19.

However, since the terminal 10b not equipped with RSVP does not transmit a Resv message which is a reply of the Path message, it is not possible to notify information from a lower stream to a upper stream.

For example, even if the relay device 21b equipped to RSVP, which received the Path message secondly, failed to be set up, it is not possible to notify it to the relay device 21a equipped with RSVP which received the Path message firstly.

In this manner, in RSVP, a setting to a relay device on a communication route becomes inadequate, unless both of transmission and reception terminals equip to RSVP.

As a matter of course, since it is not possible to transmit a Path message from the terminal 10b not equipped with RSVP, it is not possible to carry out a setting for a relay device on a route even if an opposite terminal corresponds to RSVP.

### SUMMARY OF THE INVENTION

The invention aims to realize a setting of a communication apparatus on a route, even if any one of transmission and reception terminals does not correspond to a device setting system.

By use of a function of a communication apparatus for transmitting an Echo-Reply message, and a function of a router for transmitting a Time-Exceeded message, which are essential functions of a communication apparatus and a router, by carrying out writing or reading of information to a payload of an Echo message between transmission/reception terminals and a relay device on a route, it becomes possible to write information between transmission/reception terminals and a relay device mutually.

By use of the Echo message function and the Echo-Reply message which are essential functions of a communication apparatus, it becomes possible to exchange information between devices on a communication route mutually, regardless of an ordering relation on a communication route.

In particular, in case that the information is a thing which relates to a setting, by use of the Echo message function and the Echo-Reply message which are essential functions of a communication apparatus, it becomes possible to carry out a setting to a device on a communication route, regardless of a communication partner.

In particular, in case that the information is a thing which relates to a setting status, it becomes possible for a terminal to know a setting status of a device on a communication route, regardless of a communication partner.

### BRIEF DESCRIPTION OF THE DRAWINGS

FIG. 1 is a view which shows a device setting system example (a communication device of a transmission destination is a normal terminal) in an implementation mode 1 of the invention.

FIG. 2 is a view which shows a device setting system example (a communication device of a transmission destination corresponds to extended Echo) in an implementation mode 2 of the invention.

FIGS. 3(a), 3(b) and 3(c) are views which show a payload format example of an extended Echo message in the implementation mode 2 of the invention.

FIG. 4 is a view which shows a functional block of an extended Echo corresponding terminal of the implementation mode 2 of the invention.

FIG. 5 is a view which shows a functional block of an extended Echo corresponding relay device in the implementation mode 2 of the invention.

FIGS. 6(a), 6(b) and 6(c) are views which show a device performance database which is used in an extended Echo corresponding device in the implementation mode 2 of the invention.

FIGS. 7(a), 7(b) and 7(c) are views which show a setting database which is used in the extended Echo corresponding device in the implementation mode 2 of the invention.

FIG. 8 is a flow chart which shows a processing sequence at the time of extended Echo message transmission of the extended Echo corresponding device in the implementation mode 2 of the invention.

FIG. 9 is a flow chart which show a processing sequence of a setting judgment section in the implementation mode of the invention.

FIG. 10 is a flow chart which shows a processing sequence of an extended Echo information transmission section in the implementation mode 2 of the invention.

FIG. 11 is a flow chart which shows a processing sequence at the time of extended Echo message reception of the extended Echo corresponding terminal in the implementation mode 2 of the invention.

FIG. 12 is a flow chart which shows a processing sequence of an extended Echo information transmission section in the implementation mode 2 of the invention.

FIG. 13 is a flow chart which shows a processing sequence of common processing at the time of extended Echo reply message reception during a period of processing sequences of FIGS. 11 and 14.

FIG. 14 is a flow chart which shows a processing sequence of the extended Echo corresponding relay device in the implementation mode 2 of the invention.

FIG. 15 is a flow chart which shows a QoS processing sequence example for a data flow, in a status after device setting processing completion in [pattern of setting success] in the implementation mode 2 of the invention.

FIGS. 16 (a), 16(b) and 16(c) are views which show a payload format of ICMP.

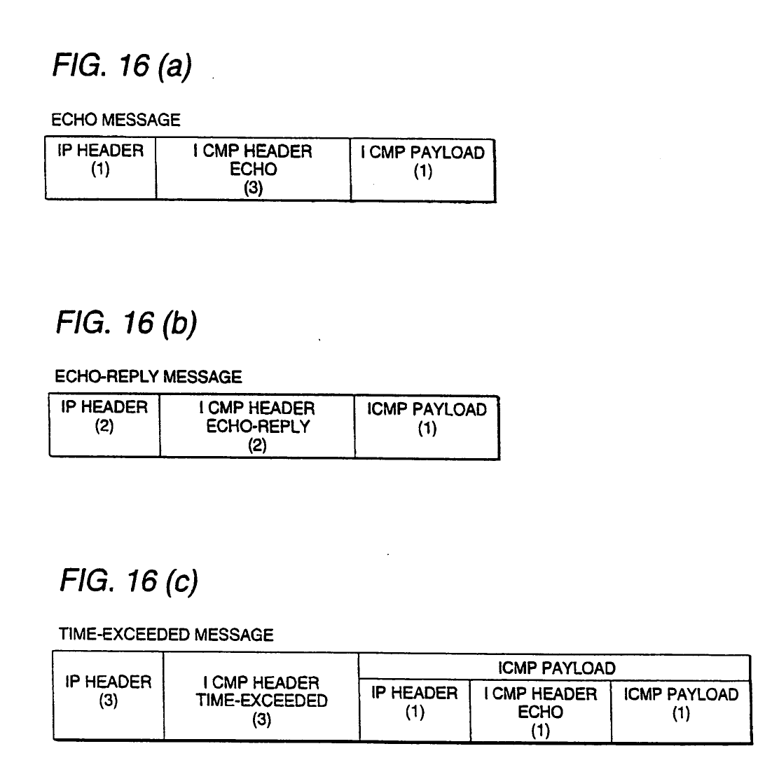

FIG. 17 is a view which shows a flow of processing of communication by use of an Echo message and an Echo-Reply message.

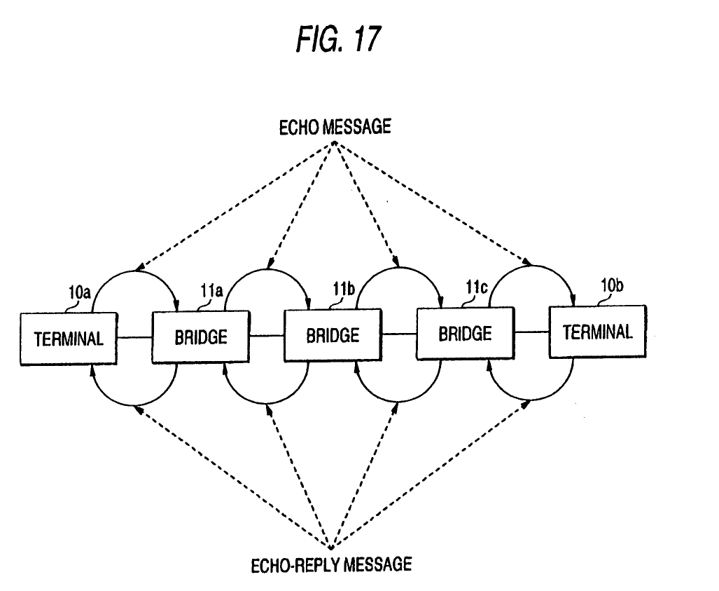

FIG. 18 is a view which shows a flow of processing of communication by use of an Echo message and a Time-Exceeded message.

FIG. 19 is a view which shows an example (setting success example) of a device setting system by use of RSVP.

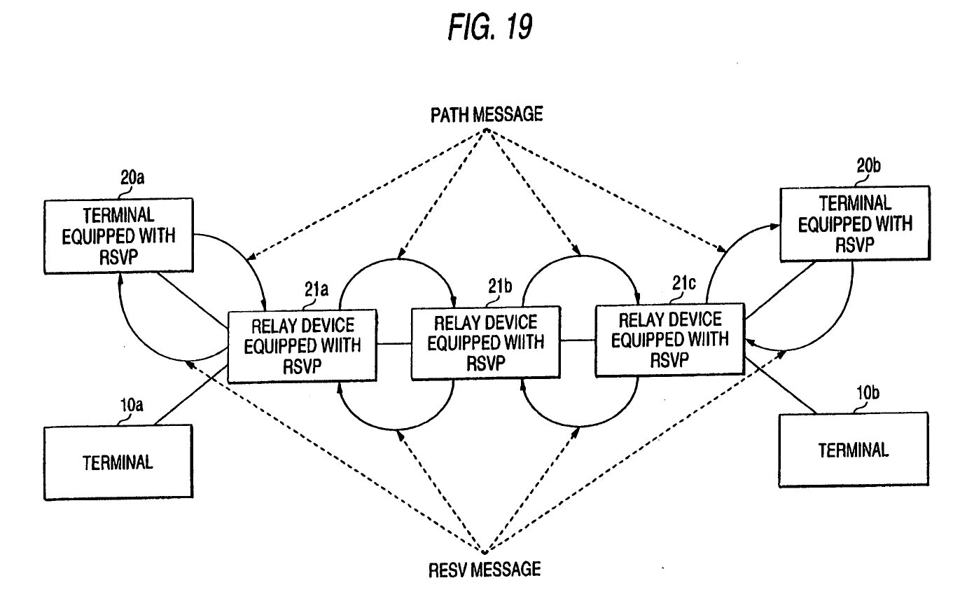

FIG. 20 is a view which shows an example (setting failure example) of a device setting system by use of RSVP.

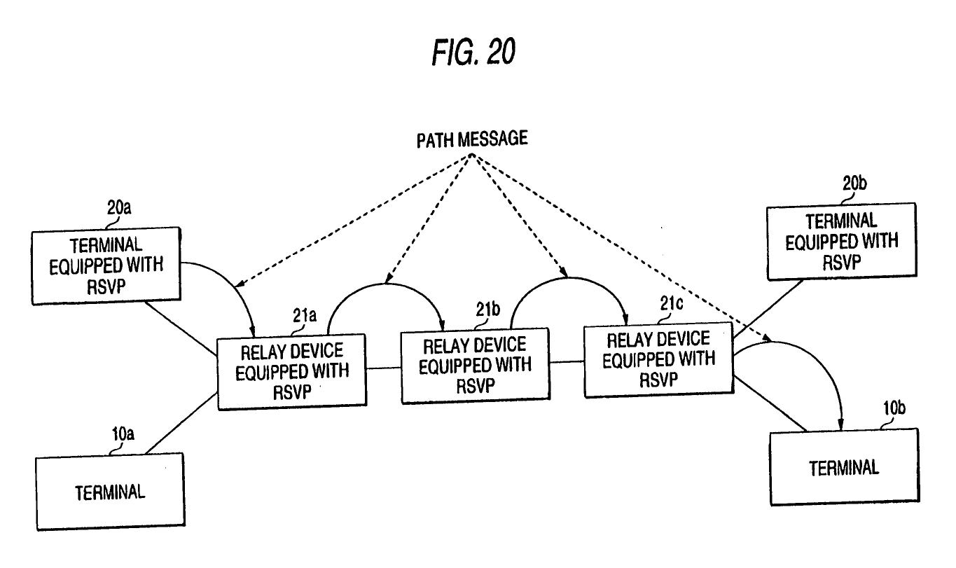

### DESCRIPTION OF THE PREFERRED EMBODIMENTS

A mode for carrying out the invention is a thing which is configured so as to transmit an ICMP message in which information to at least one of a destination terminal for the ICMP message and a relay device on a route to the destination terminal is written in a payload of the ICMP message.

By this configuration, by having a function of writing information in a message of ICMP by which it is possible to exchange information of a device on a communication route, it is possible to notify information of this communication apparatus to another device on a communication route.

In addition, another mode for carrying out the invention is a thing which is configured so as to obtain information to at least one of a destination terminal for the ICMP message and a relay device on a route to the destination terminal, from a payload of the ICMP message.

By this configuration, by having a function of reading information from a message of ICMP by which it is possible to exchange information of a device on a communication route, it is possible to obtain information of another device on a communication route, by this communication apparatus.

In addition, another mode for carrying out the invention is a thing which is configured so as to obtain information to at least one of an extended Echo information transmission section which transmits the ICMP message in which information to at least one of a destination terminal for an ICMP message and a relay device on a route to the destination terminal is written in a payload of the ICMP message, the destination terminal for the ICMP message, and the relay device on the route to the destination terminal, from the payload of the ICMP message.

By this configuration, by having a function of writing information to a message of ICMP by which it is possible to exchange information of a device on a communication route, it is possible to notify information of this communication apparatus to another device on a communication route, and by having a function of reading information from a message of ICMP by which it is possible to exchange information of a device on a communication route, it is possible to obtain information of another device on a communication route, by this communication apparatus.

Further, by using at least one of an Echo message, an Echo-Reply message, and a Time-Exceeded message, as the ICMP message, it is possible to exchange mutual information, by use of an essential function of a communication apparatus.

In addition, by using information regarding QoS as the information to at least one of a destination terminal for an ICMP message and a relay device on a route to the destination terminal, it is possible to exchange information regarding QoS mutually.

In addition, by having a setting database section stored the information to at least one of a destination terminal for the ICMP message and a relay device on a route to the destination terminal, a communication application refers to the stored information, and can judge whether a setting to a device is completed or not.

Further, by reading out the information to at least one of a destination terminal for the ICMP message and a relay device on a route to the destination terminal and carrying out judgment of QoS of the communication apparatus, on the basis of the information, it is possible to exchange information regarding QoS mutually, and to carry out a setting of QoS to a communication apparatus.

Implementation Mode 1

Hereinafter, a mode for implementing the invention will be described on the basis of each figure.

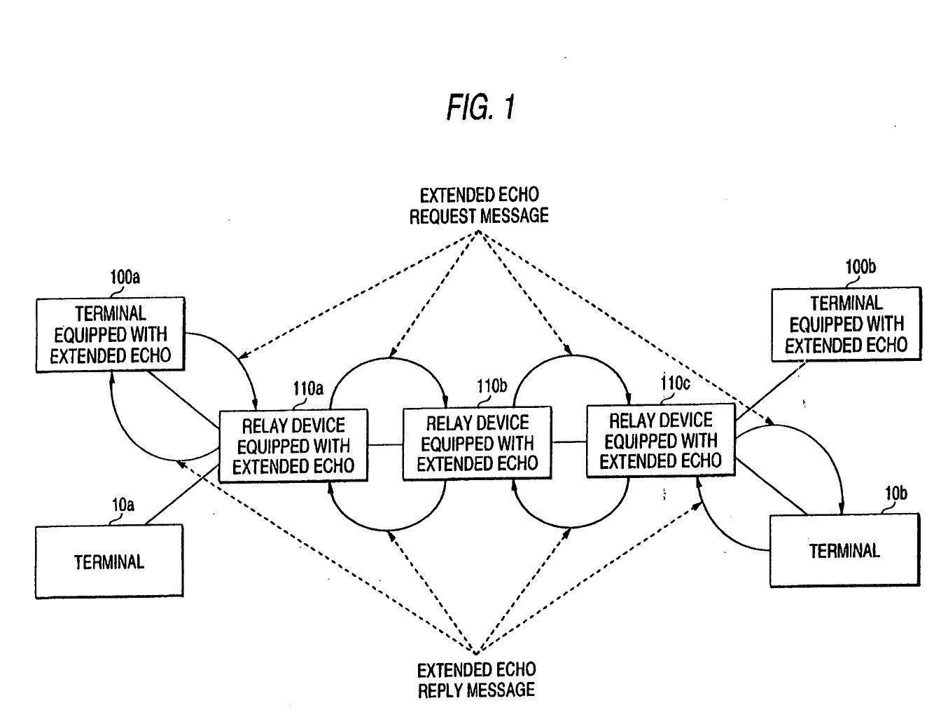

FIG. 1 shows a view which shows a device setting system example (a communication apparatus at a destination is a normal terminal) of an implementation mode 1 of the invention.

In order to simplify subsequent explanations, it is defined that an Echo message in which setting information is included in a payload, an Echo-reply message, and a Time-Exceeded message are called as extended Echo messages. In addition, it is defined that an Echo message, in which setting information is included in a payload, is called as an extended Echo request message, and an Echo-Reply message and a Time-Exceeded message, which are replies to the Echo message, are called as extended Echo reply messages.

100a, 100b designate extended Echo corresponding terminal which correspond to this system, and 10a, 10b designate conventional IP corresponding terminals which have ICMP functions.

110a, 110b, and 110c designate extended Echo corresponding relay devices.

The extended Echo corresponding terminal 100a transmits an extended Echo request message in which setting information was written in a payload, toward the terminal 10b which is a destination.

This extended Echo request message is relayed by the extended Echo corresponding relay devices 110a, 110b, and 110c, and reaches to the terminal 10b which is a destination.

The extended Echo corresponding relay device 110 carries out reading of information which was written in a payload of the extended Echo request message and writing a processing result based on the information written in the payload to a predetermined position of the payload, in the same manner as in the case of RSVP.

By this extended Echo request message, it is possible to realize such an advantage that setting information which was written in a payload and a processing result of a upper stream relay device are notified to a lower stream relay device and the reception terminal 10b, which is the same as in the Path message of RSVP.

The terminal 10b, which received this extended Echo request message, transmits Echo-Reply, by a function of ICMP which is an essential function. In addition, since a payload of the Echo message is copied on this Echo-Reply message by an essential function of ICMP, it becomes an extended Echo reply message in which setting information was written in a payload.

By this extended Echo reply message, it is possible to realize such an advantage that setting information and a processing result of a lower stream relay device are notified to a upper stream relay device and the extended Echo request message transmission terminal 100a, which is the same manner as in the Resv message of RSVP.

Further, by changing a value of TTL at the time of transmission of the extended Echo request message, the extended Echo reply message is changed to a Time-Exceeded message from a router, and thereby, it also becomes possible to restrict to a part of relay devices on a route but all of them.

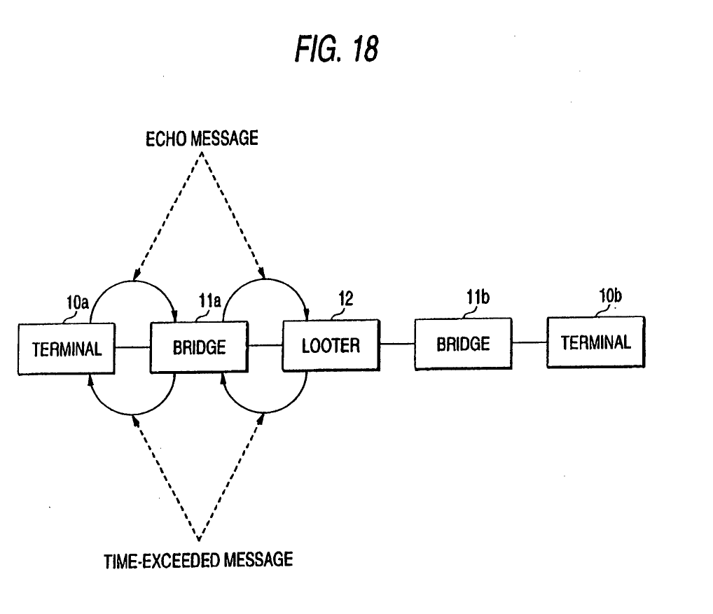

For example, in the same manner as in the case of FIG. 18, an Echo message, in which TTL=1 was set up, is folded back as a Time-Exceeded message by a first router, and thereby, it becomes to restrict a setting object up to the first router.

Implementation Mode 2

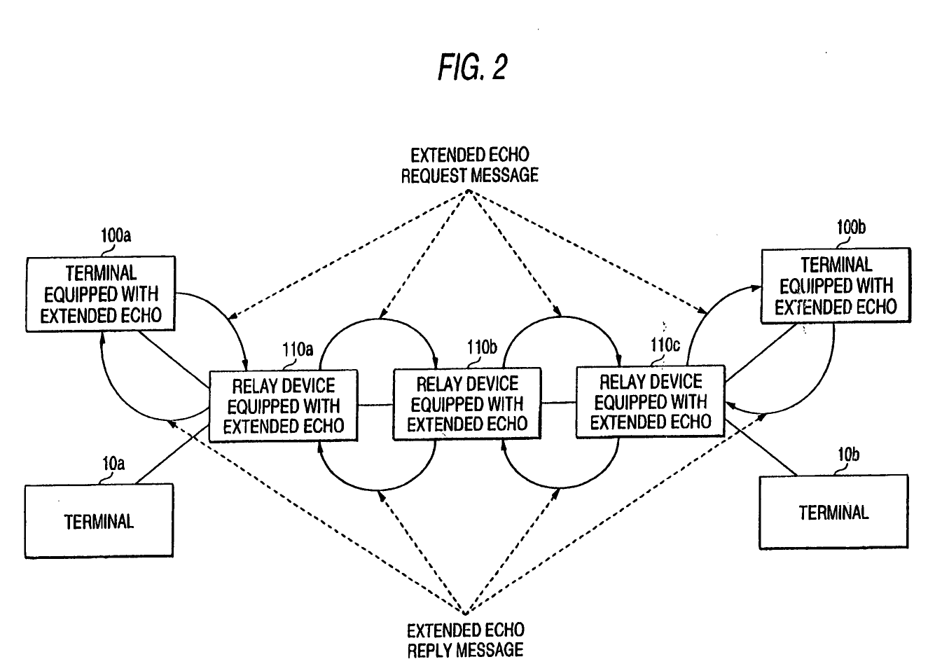

FIG. 2 is a view which shows a device setting system example (a communication device at a transmission destination corresponds to extended Echo) of an implementation mode 2 of the invention.

100 designates an extended Echo corresponding terminal, and 10 designates a terminal.

Extended Echo corresponding terminals 100a, 110b, and terminals 10a, 10b are set to IP addresses (10.0.0.100), (10.0.0.200), (10.0.0.10), and (10.0.0.20), respectively. 110 designates an extended Echo corresponding relay device.

The extended Echo corresponding terminals 100a, 110b, and the terminals 10a, 10b are connected by extended Echo corresponding relay devices 110a, 110b, and 110c.

In a system configuration example of FIG. 2, device setting processing regarding QoS of a flow of data which is transmitted from the extended Echo corresponding terminal 100a to the extended Echo corresponding terminal 100b will be described.

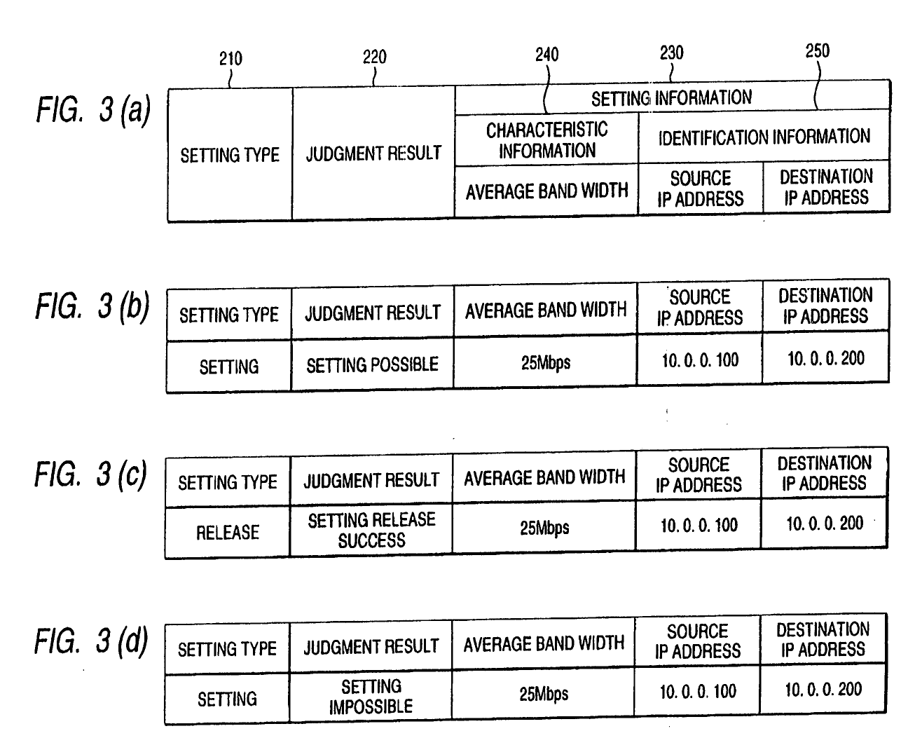

FIG. 3 is a view which shows a payload format example of an extended Echo message in the implementation mode 2 of the invention.

Meanwhile, in FIG. 3, only an ICMP payload is described.

In this implementation mode, an ICMP payload of an extended Echo message which is used for a setting is composed of “setting type” 210, “judgment result” 220, and “setting information” 230.

The “setting information” 230 is further composed of “characteristic information” 240, and “identification information” 250.

Hereinafter, an explanation of each parameter will be carried out.

The “setting type” 210 represents a type of a setting to a device on a communication route.

In this implementation mode, two values of “setting” and “release” can be taken as the setting type.

In case of setting to each device on a communication route, a setting content is specified in the “setting information” in a payload, and “setting” is specified in the “setting type”.

In case of releasing a setting of each device on a communication route, a releasing content is specified in the “setting information” in a period, “release” is specified in the “setting type”.

Meanwhile, in addition to the “setting” and “release” which are used in this implementation mode, it is possible to use a value relating to a setting, such as “setting change”, “setting confirmation” and so on, and even if these are used, an advantage of the invention does not change.

The “judgment result” 220 represents an each device's judgment result of whether a setting of a device on a communication route can be carried out or not.

In this implementation mode, 5 values of “no setting target device”, “setting possible”, “setting impossible”, “no setting release target device”, and “setting release success” can be taken.

The “no setting target device” represents that a device, which equips to this device setting system, does not exist on a route, in the route to a device which received from a terminal that transmitted a message.

The “setting possible” represents that it is possible to set up all devices which equips to this device setting system, on a route.

The “setting impossible” represents that it was impossible to set up one or more devices among devices which correspond to this device setting system, on a route.

The “no setting release target device” represents that there was not a device which holds “setting information” specified in a payload, on a route.

The “setting release success” represents that specified “setting information” was deleted from all devices holding “setting information”, which was specified in a payload, on a communication route.

The “characteristic information” 240 is information which represents a characteristic such as a band width of a data flow.

In this implementation mode, “average band width” of a data flow is used.

Meanwhile, in addition to the “average band width” which is used in this implementation mode, it is possible to use information which represents a characteristic of a data flow such as “maximum band” representing a maximum band of a data flow and “delay upper limit” representing a upper limit of delay which is allowed in a data flow, and even if these are used, an advantage of the invention does not change.

The “identification information” 250 is information for identifying a data flow.

In this implementation mode, “source IP address” and destination IP address”, which are IP addresses of transmission and reception devices of a data flow, are used.

Meanwhile, as the “identification information”, in addition to IP addresses of transmission and reception devices, it is possible to use information for specifying a data flow, such as transmission and reception port numbers of transmission and reception devices, and MAC addresses, and even if these are used, an advantage of the invention does not change.

Hereinafter, an Echo message, in which a type of ICMP is “Echo”, is called as “extended Echo request message”, and an extended Echo message, in which a type of ICMP is “Echo-Reply” and “Time-Exceeded”, is called as “extended Echo reply message”.

Further, an extended Echo request message, in which “setting type” is “setting”, is called as “extended Echo request message (setting)”, and an extended Echo reply message, in which “setting type” is “setting”, is called as “extended Echo reply message (setting)”.

In the same manner, an extended Echo request message, in which “setting type” is “release”, is called as “extended Echo request message (release)”, and an extended Echo reply message, in which “setting type” is “release”, is called as “extended Echo reply message (release)”.

The extended Echo corresponding terminal 100 transmits an extended Echo message to the extended Echo corresponding terminal 100 or the terminal 10, and thereby, it is possible to carry out a device setting to the extended Echo corresponding relay device on a communication route.

Meanwhile, in case that a destination is the extended Echo corresponding terminal 100, a device setting is carried out to not only the extended Echo corresponding relay device 110 on a communication route but also an extended Echo corresponding terminal which is a destination.

Next, functional blocks of the extended Echo corresponding terminal 100 and the extended Echo corresponding relay device 110 will be described.

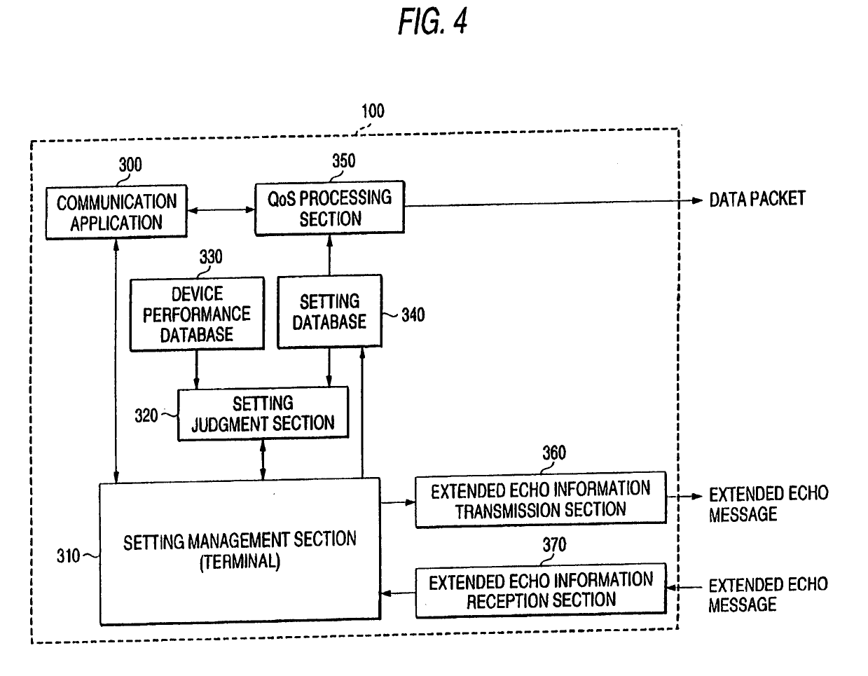

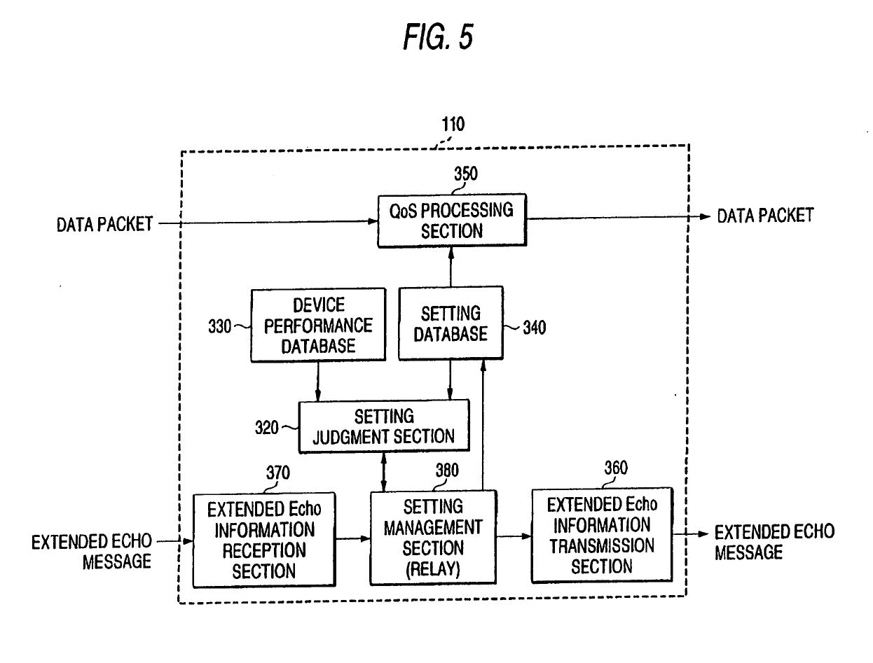

FIG. 4 is a view which shows a functional block of the extended Echo corresponding terminal 100 in the implementation mode 2 of the invention. In addition, FIG. 5 is a view which shows a functional block of the extended Echo corresponding relay device in the implementation mode 2 of the invention.

By use of FIG. 4, a function of the extended Echo corresponding terminal 100 will be described, and in addition, by use of FIG. 5, a function of the extended Echo corresponding relay device 110 will be described.

Common blocks in the functional blocks of the extended Echo corresponding terminal 100 and the extended Echo corresponding relay device 110 shown in FIGS. 4 and 5 are a setting judgment section 320, a device performance database 330, a setting database 340, a QoS processing section 350, an extended Echo information transmission section 360, and an extended Echo information transmission section 370.

Hereinafter, explanations of each functional block will be carried out.

A communication application 300 of the extended Echo corresponding terminal 100 is an application for carrying out data communication which requires QoS.

The device performance database 330 is a database of device performance information which is information representing a function and performance inherent to each device.

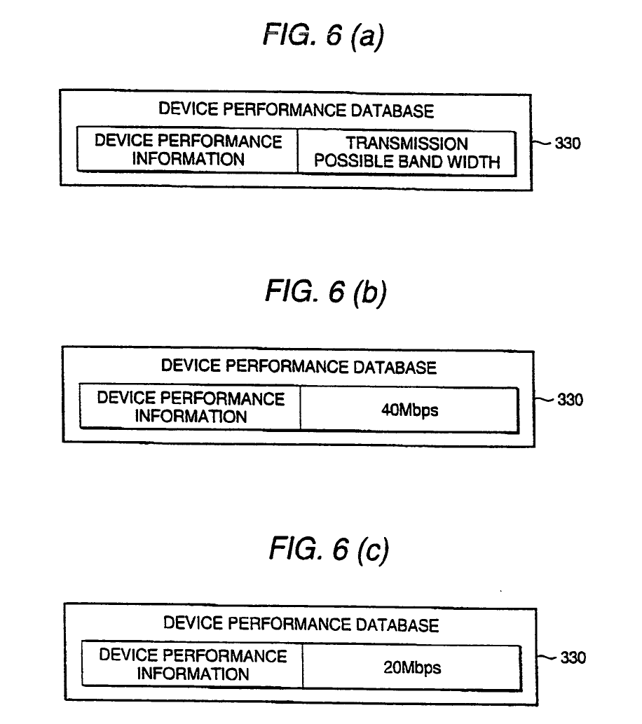

FIG. 6 is a view which shows a device performance database that is used in an extended Echo corresponding device of the implementation mode 2 of the invention.

As shown in (a) of FIG. 6, in this implementation mode, “transmission possible band width” is used as device performance.

The “transmission possible band width” parameter represents a maximum band width which can be used in such a state that a setting is not carried out for each device.

The setting database 340 is a database in which parameters for controlling the QoS processing section 350 were collected.

The QoS processing section carries out QoS control in accordance with a content of this setting database 340.

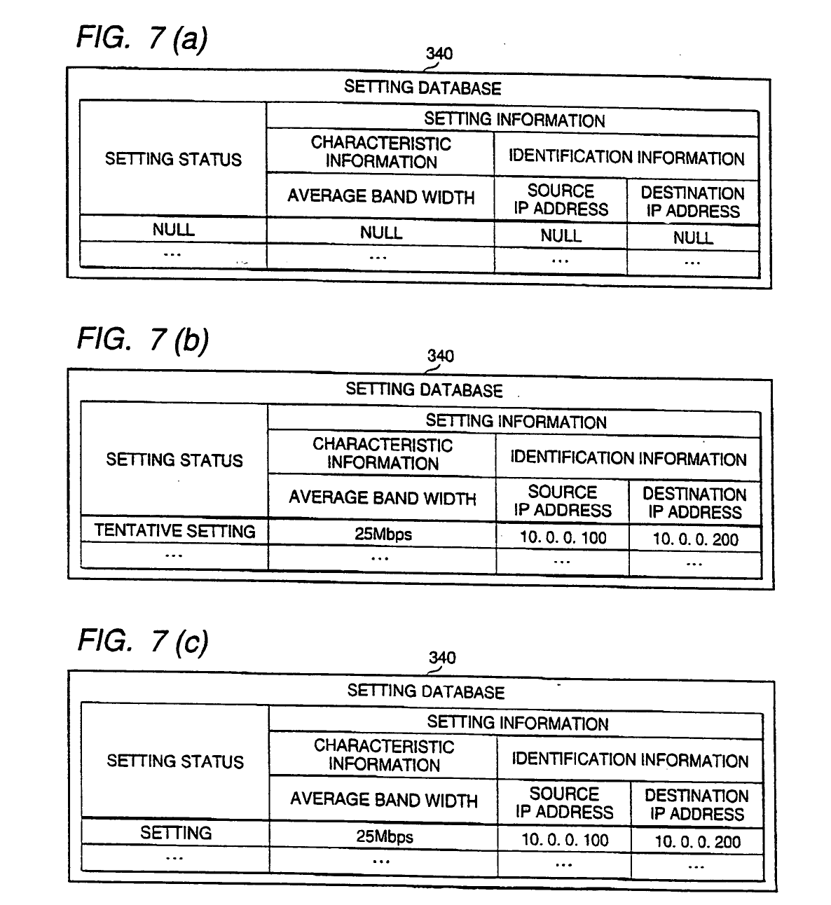

FIG. 7 is a view which shows a setting database that is used in a device equipped with extended Echo of the implementation mode 2 of the invention.

As shown in FIG. 7, in this implementation mode, the setting database 340 is composed of “setting information” and “setting status” of that setting information.

As the “setting status” parameter, two values of “tentative setting” and “setting” are used in the terminal 100 equipped with extended Echo and the relay device 110 equipped with extended Echo.

When the “setting information” is of a value of “tentative setting”, it shows a status of keeping up such a status that, until an extended Echo corresponding device receives an extended Echo reply message (setting), corresponding “setting information” can be set up.

When the “setting information” is of a value of “setting” the QoS processing section 350 carries out communication quality assurance which complies with “characteristic information” of a data flow specified by “identification information”.

In this implementation mode, the QoS processing section 350 carries out band width assurance of “average band width”.

The setting judgment section 320 has a function of judging whether “setting information” of an extended Echo message can be set up to this extended Echo corresponding device, from information of the setting database 340, and information which is notified from a setting management section (terminal) 310 or a setting management section (relay) 380.

Hereinafter, a judgment result which was acquired from an extended Echo message in an extended Echo information transmission section 370, or a judgment result which was set up in the setting management section (terminal) 310 or the setting management section (relay) 380 is called as “judgment result”, and a result of judgment which was carried out by the setting judgment section 320 is called as “judgment result of this device”.

The setting management section (terminal) 310 inquires whether a setting is possible to the setting judgment section 320, from information which was notified from the communication application 300 or information which was acquired in the extended Echo information section 370, and acquires “judgment result of this device” from the setting judgment section 320.

The setting management section (terminal) 310 changes the setting database 340 depending on “judgment result of this device”, and notifies values of “ICMP type”, “setting type”, “setting information”, and “judgment result of this device” to the extended Echo information transmission section 360.

The setting management section (relay) 380 inquires whether a setting is possible to the setting judgment section 320, from information which was acquired in the extended Echo information reception section 370, and acquires “judgment result of this device” from the setting judgment section 320.

The setting management section (relay) 380 further changes the setting database 340 depending on “judgment result of this device”, and notifies values of “ICMP type”, “setting type”, “setting information”, and “judgment result of this device” to the extended Echo information transmission section 360.

The extended Echo information transmission section 360 has a function of transmitting an extended Echo message in which “ICMP type”, “setting type”, “setting information”, and “judgment result of this device”, which were notified from the setting management section (terminal) 310 or the setting management section (relay) 380, were written in a payload.

At this time, a judgment result field is updated by the “judgment result of this device”.

The extended Echo information transmission section 370 acquires “ICMP type”, “setting type”, “setting information”, and “judgment result” which have been written in a payload of the received extended Echo message.

In the above-described device setting system of FIG. 2, [pattern of setting success], [pattern of setting release], and [pattern of setting failure] of device setting processing for carrying out communication quality of a data flow of 25 Mbps which is transmitted from the terminal 100a equipped with extended Echo to the terminal 100b equipped with extended Echo will be described.

Pattern of Setting Success

By use of FIG. 2, an operation in such a case that a device setting for carrying out QoS of a data flow becomes successful will be descried.

Firstly, pre-device setting statuses of terminal 100 equipped with each extended Echo and relay device 110 equipped with each extended Echo will be shown.

All of device performance databases 330 of terminals 100a, 100b equipped with extended Echo, and relay devices 110a, 110b, and 110c e equipped with extended Echo come into a status of (b) of FIG. 6.

In addition, all of device performance databases 340 of the terminals 100a, 100b equipped with extended Echo, and the relay devices 110a, 110b, and 110c equipped with extended Echo come into a status of (a) of FIG. 7.

Meanwhile, Null in (a) of FIG. 7 is a value which represents that information is not set up.

Processing of the terminal 100a equipped with extended Echo, which transmits “setting information” for carrying out a device setting, will be described.

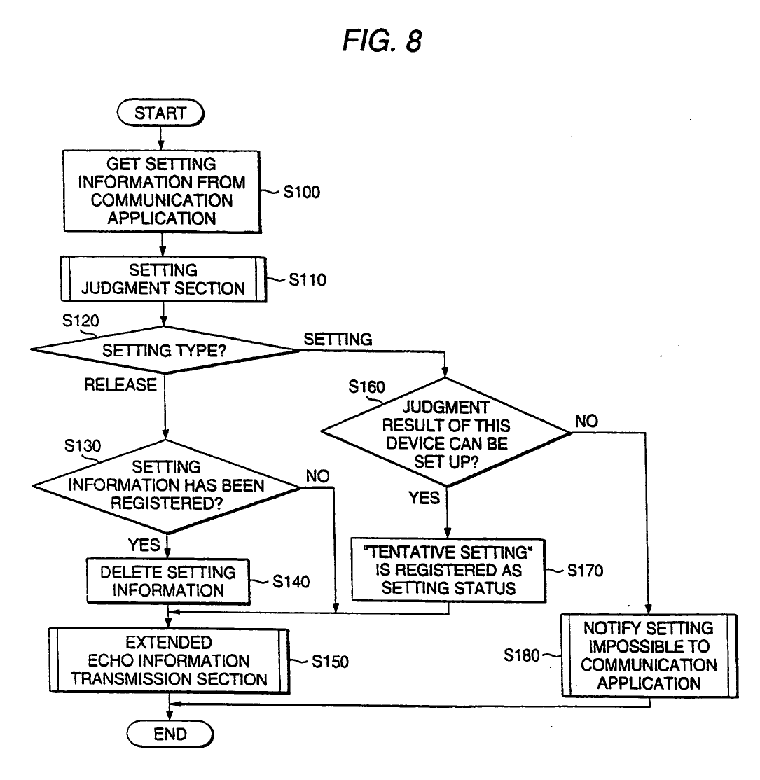

FIGS. 8, 9, 10, 11, 12, and 13 are processing sequences of the terminal 100 equipped with extended Echo.

FIG. 8 is a flow chart which shows a processing sequence of an terminal equipped with extended Echo in the implementation mode 2 of the invention, at the time of extended Echo message transmission.

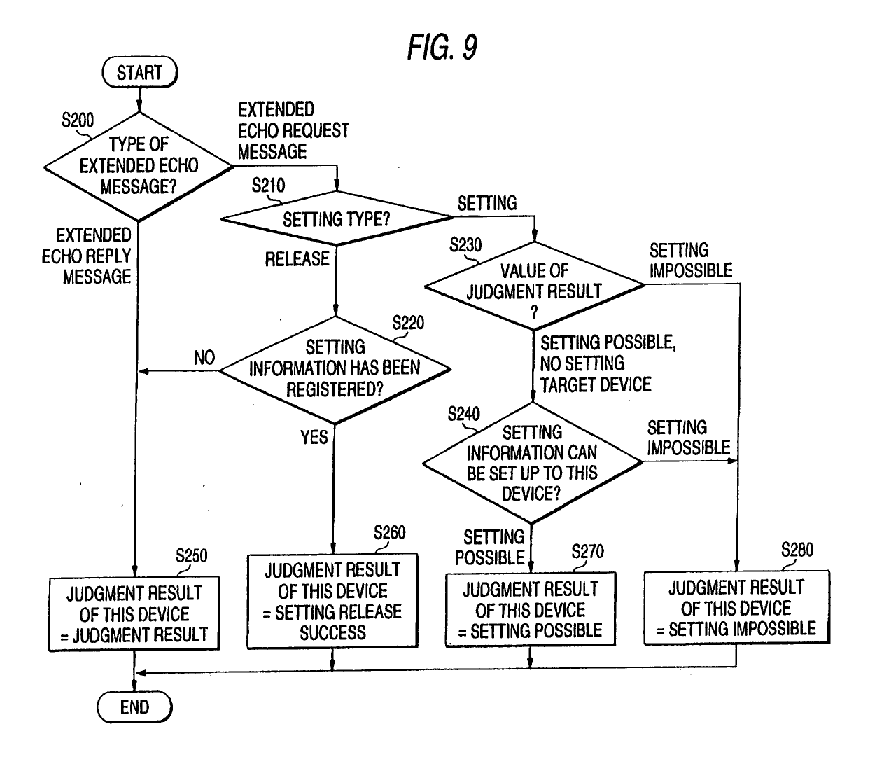

FIG. 9 is a flow chart which shows a processing sequence of the setting judgment section 320 in the implementation mode 2 of the invention.

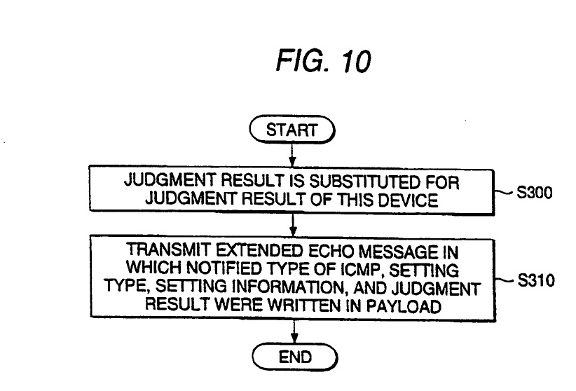

FIG. 10 is a flow chart which shows a processing sequence of an extended Echo information transmission section in the implementation mode 2 of the invention.

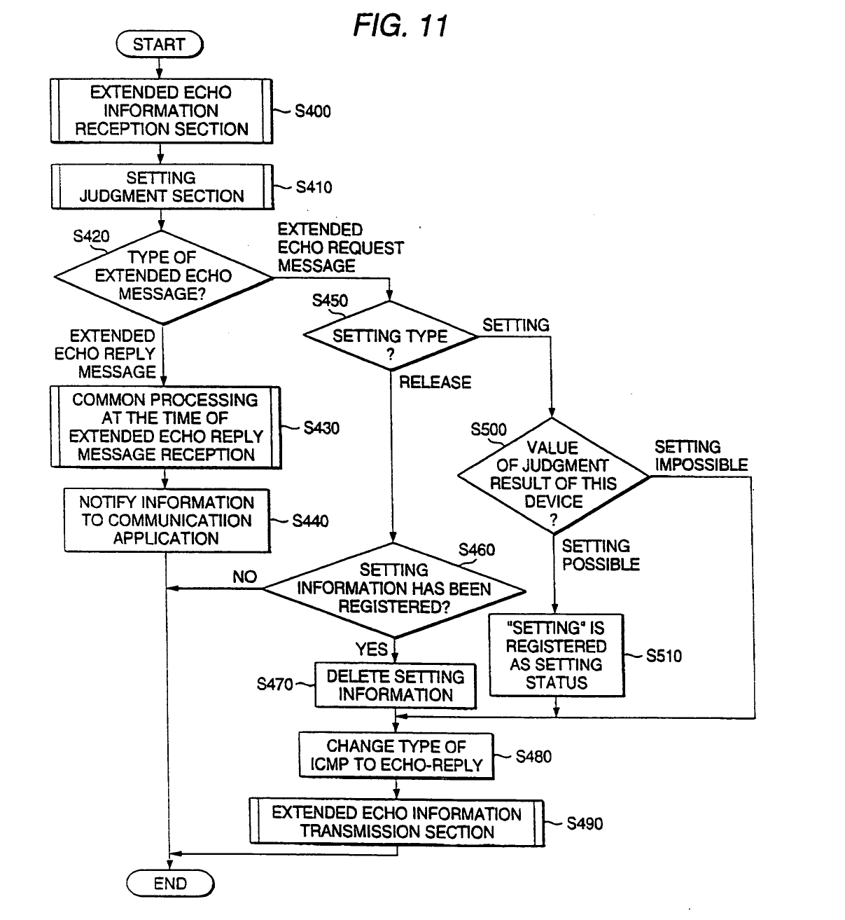

FIG. 11 is a flow chart which shows a processing sequence of an terminal equipped with extended Echo in the implementation mode 2 of the invention, at the time of extended Echo message reception.

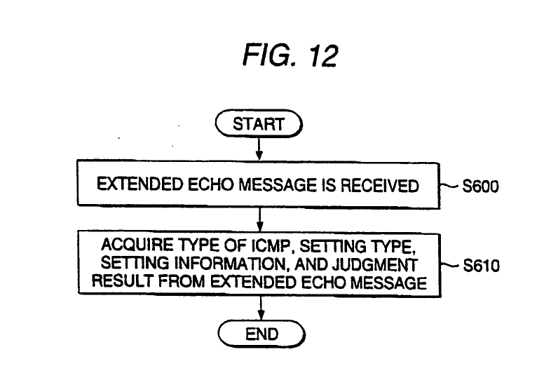

FIG. 12 is a flow chart which shows a processing sequence of an extended Echo information transmission section in the implementation mode 2 of the invention.

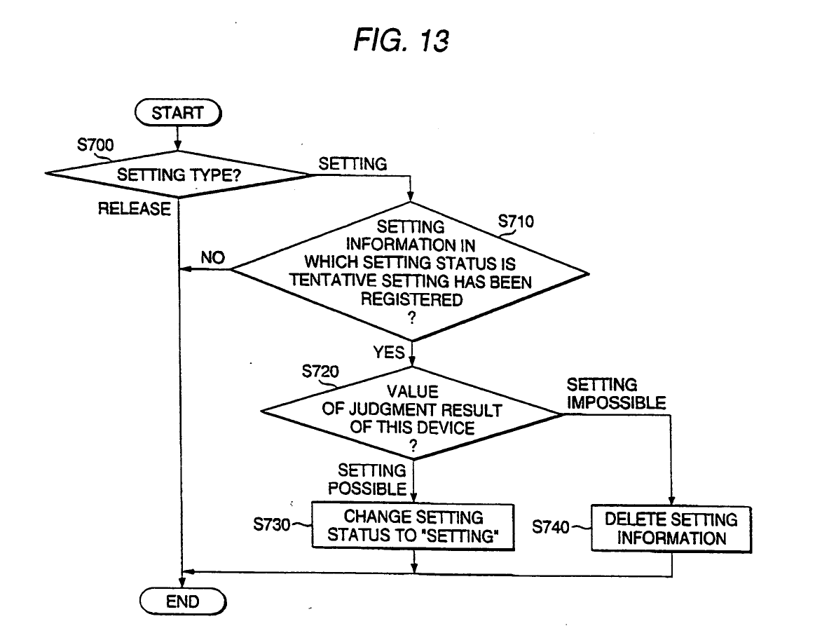

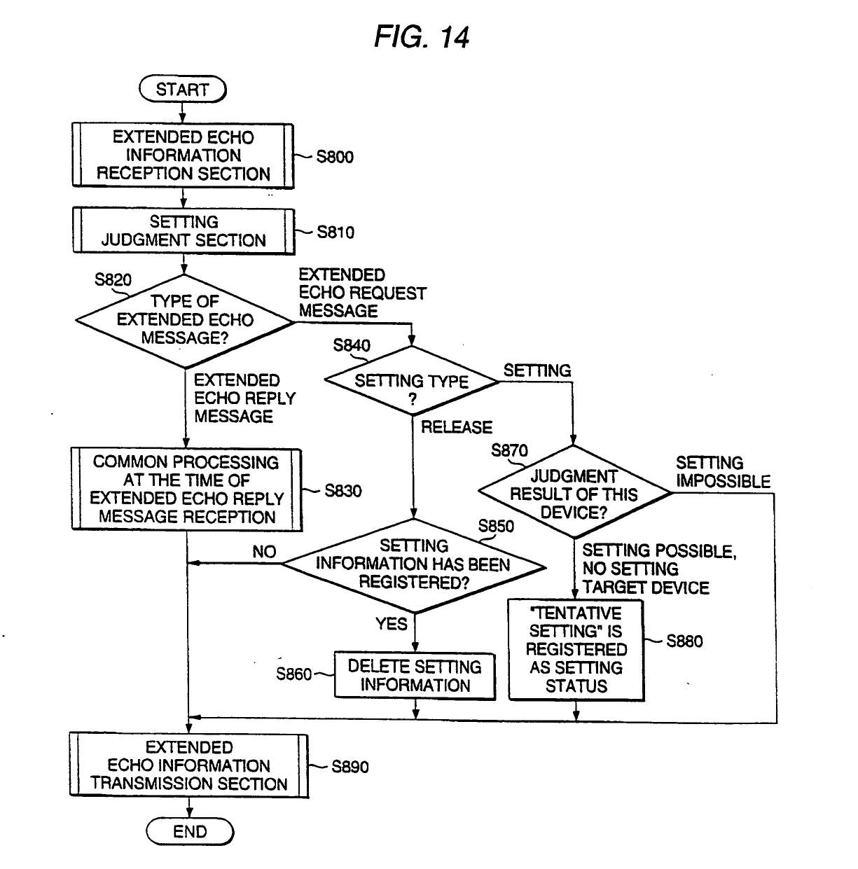

FIG. 13 is a flow chart which shows a processing sequence of common processing at the time of extended Echo reply message reception in the processing sequence of FIGS. 11 and 14.

In the setting management section (terminal) 310, the communication application 300 notifies “setting information” for carrying out QoS of such a data flow that “setting type” is “setting” and a transmission source IP address is (10.0.0.100) and a destination IP address is (10.0.0.200) and an average band width is 25 Mbps, to the setting management section (terminal) 310 (step S100).

The setting management section (terminal) 310 notifies “type of ICMP”, “setting type”, “judgment result” and “setting information” to the setting judgment section 320, and makes an inquiry about “judgment result of this device” (step S110).

Here, since “setting type” is “setting”, “type of ICMP” has become Echo, and a value of “judgment result” has become “no setting target device”.

The setting judgment section 320 identifies whether inputted information is an extended Echo request message, or an extended Echo reply message (step S200).

Since “type of ICMP” is Echo, judgment of “setting type” is carried out (step S210).

Since “setting type” is “setting” and “judgment result”has become “no setting target device” (step S230), judgment of whether “setting information” can be set up to this device is carried out (step S240).

In a step S240, since there is no registration of “setting information” in the setting database 340 and the device performance database 330 is in such a status that “transmission possible bandwidth” is 40 Mbps, it is judged that a setting for securing a band width of 25 Mbps, which is required by “setting information”, is possible.

Therefore, since a setting is possible to this device, “judgment result of this device” is set to “setting possible” (step S270).

The setting management section (terminal) 310, to which “judgment result of this device” was notified, carries out judgment of “setting type” (step S120).

Since “setting type” is “setting”, a value of “judgment result of this device” is referred (step S160).

Since “judgment result of this device” is “setting possible”, “setting information” is registered as “tentative setting” in the setting database 340 (step S170).

To the extended Echo information transmission section 360, “type of ICMP”, “setting type”, “setting information” and “judgment result of this device” are notified (step S150).

In the extended Echo information transmission section 360, “judgment result of this device” is set to “judgment result” which is described in an extended Echo message (step S300).

An extended Echo request message (setting), in which “setting type”, “setting information” and “judgment result” were written in a payload and “type of ICMP” is Echo, is transmitted (step S310).

At this time, a value of each parameter of the extended Echo request message (setting), which is transmitted from the extended Echo corresponding terminal 100a, has become as shown in (b) of FIG. 3, and data of the setting database 340 has become as shown in (b) of FIG. 7.

Next, processing of the extended Echo corresponding relay device 110, which relays an extended Echo message, will be described.

FIG. 14 is a flow chart which shows a processing sequence of an extended Echo corresponding relay device in the implementation mode 2 of the invention, and processing sequences of the setting judgment section 320, the extended Echo information transmission section 360, and the extended Echo information transmission section 370 have become as shown in FIGS. 9, 10, and 12, in the same manner as in the extended Echo corresponding terminal 100, respectively. Common processing at the time of extended Echo response message reception in FIG. 14 has become as shown in FIG. 13, in the same manner as the extended Echo corresponding terminal 100. Processing in the extended Echo corresponding relay device 110 at the time that it receives the extended Echo request message (setting) will be hereinafter shown.

The extended Echo corresponding relay device 110a receives an extended Echo message by the extended Echo information transmission section 370 (step S800, step S600).

From the extended Echo message, “type of ICMP”, “setting type”, “setting information”, and “judgment result” are acquired (step S610).

The setting management section (relay) 380 notifies the acquired information to the setting judgment section 320, and inquires about “judgment result of this device” (step S810).

Since processing of the setting judgment section 320 is simply different from processing of the setting judgment section 320 in the extended Echo corresponding terminal 100a on such a point that a value of “judgment result” as a judgment condition in the step S230 is “setting possible” and a flow of processing is the same, “setting possible” as “judgment result of this device” is notified to the setting management section (relay) 380.

The setting management section (relay) 380, after “judgment result of this device” was notified thereto, identifies whether an inputted message is an extended Echo request message, or an extended Echo reply message (step S820).

Since “type of ICMP” is Echo, it judges that it is the extended Echo request message and carries out a setting of “setting type” (step S840).

Since “setting type” is “setting” and “judgment result of this device” is “setting possible” (step S870), “tentative setting” is registered in the setting database 340 as “setting information” (step S880), and “type of ICMP”, “setting type”, “setting information”, and “judgment result of this device” are notified to the extended Echo information transmission section 360 (step S890).

Since subsequent processing in the extended Echo information transmission section 360 is the same as in the extended Echo corresponding terminal 100a, explanations will be omitted.

At this time, data of the setting database 340 has become as shown in (b) of FIG. 7.

In the extended Echo corresponding relay devices 110b and 110c, the same processing as in the extended Echo corresponding relay device 110a is carried out.

At this time, data of the setting database 340 in the both extended Echo corresponding relay devices, has become as shown in (b) of FIG. 7.

Processing of the extended Echo corresponding terminal 100b, which replies to an extended Echo message, will be described.

In the extended Echo corresponding terminal 100b, after an extended Echo message was received by the extended Echo information transmission section 370 (step S400, step S600), “type of ICMP”, “setting type”, “setting information”, and “judgment result” are acquired from the extended Echo message, and notified to the setting management section (terminal) 310 (step S610).

The setting management section (terminal) 310 notifies the acquired information to the setting judgment section 320, and makes an inquiry about “judgment result of this device” (step S410).

Since processing of the setting judgment section 320 is the same as in the extended Echo corresponding relay device 100a with regard to a flow of processing, “setting possible” is notified to the setting management section (terminal) 310 as “judgment result of this device”.

The setting management section (terminal) 310 identifies whether an inputted message is an extended Echo request message or an extended Echo reply message (step S420), after “judgment result of this device” was notified thereto, and since “type of ICMP” is Echo, it judges that it is the extended Echo request message, and carries out a setting of “setting type” (step S450).

Since “setting type” is “setting”, a value of “judgment result of this device” is referred (step S500).

Since “judgment result of this device” is “setting possible”, “setting” is registered in the setting database 230 as “setting information” (step S510), and “type of ICMP” is changed to Echo-Reply (step S480), and “type of ICMP”, “setting type”, “setting information”, and “judgment result of this device” are notified to the extended Echo information transmission section 360 (step S490).

In the step S490, an extended Echo reply message (setting) is transmitted to the extended Echo corresponding terminal 100a, but since detail of processing is the same as processing of the extended Echo corresponding terminal 100a, an explanation will be omitted.

At this time, data of the setting database 340 has become as shown in (c) of FIG. 7.

Processing of the extended Echo corresponding relay device 110, which received the extended Echo reply message (setting), will be described.

Since proceeding up to the step S200 in the setting judgment section 210 in the step S810 is the same as processing explained in the extended Echo corresponding relay device 110a, an explanation will be omitted.

In judgment of a type of an extended Echo message in the step S200, since “type of ICMP”, which was acquired from the received extended Echo message, is “Echo-Reply”, it is judged that it is an extended Echo reply message, and a value of “judgment result”, which was acquired from the extended Echo message, is copied to “judgment result of this device”, and notified to the setting management section (relay) 380 (step S250).

In the setting management section (relay) 380, extended Echo message type judgment was carried out in the same manner as the step S200 of the setting judgment section 320, and as a result, it is found that it is an extended Echo reply message (step S820, step S830).

Since “setting type” is “setting” (step S700), it is investigated whether “tentative setting” is registered in the setting database 340 as “setting status” of “setting information” (step S710).

As a result of investigation, since it was registered, “judgment result of this device” is referred (step S720), and since “judgment result of this device” is “setting possible”, “setting status” of “setting information”, which has been registered in the setting database 340, is changed to “setting” (step S730).

Since processing in the extended Echo information transmission section 360 in a subsequent step S890 is the same as processing of the extended Echo corresponding relay device 110a, an explanation will be omitted.

At this time, data of the setting database 340 has become as shown in (c) of FIG. 7.

Since processing of the extended Echo corresponding relay devices 110b and 110a at the time that they received an extended Echo reply message (setting) is the same as processing of the extended Echo corresponding relay device 110c at the time that it receives the above-descried extended Echo reply message (setting), an explanation will be omitted.

At this time, data of the setting database 340 of the relay devices equipped with both extended Echo has become as shown in (c) of FIG. 7.

Processing of the terminal 100a equipped with extended Echo at the time that it received an extended Echo reply message (setting) will be described.

Since processing up to the step S440 is the same as processing of the relay device 10c equipped with extended Echo which received the extended Echo reply message, an explanation will be omitted.

In the step S440, the acquired “judgment result of this device” is notified to the communication application 300 as a judgment result of a setting of a device on a route.

At this time, all of values of the setting databases 340 of the terminals 100a, 100b equipped with extended Echo, and the relay devices 110a, 110b, and 110c equipped with extended Echo have become as shown in (c) of FIG. 7, and it can be said that unified device settings of the terminal 100 equipped with extended Echo and the relay device 110 equipped with extended Echo on a communication route in the [pattern of setting success] could be carried out.

In addition, it is possible to know a judgment result of whether the communication application could be also set up or not.

Data Flow Transmission Processing After Setting Success

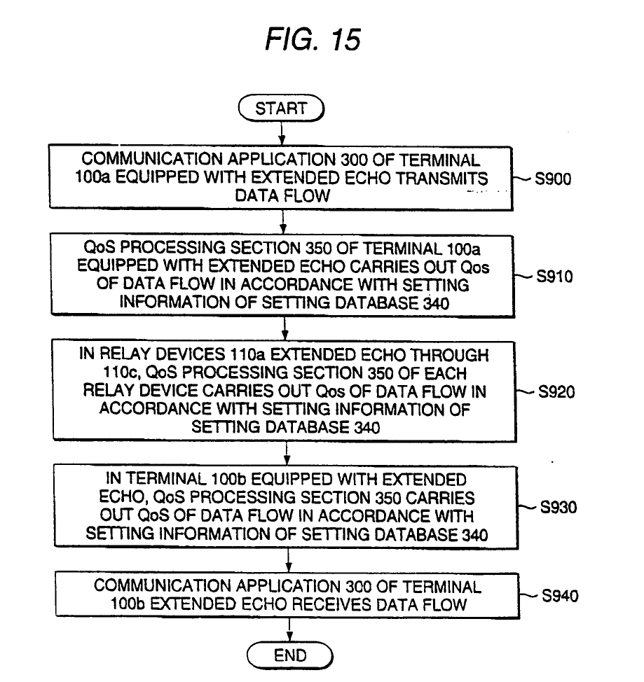

Processing of each device at the time of flowing a data flow of “setting information” specified by the [pattern of setting success] from the communication application 300 of the extended Echo equipping terminal 100a up to the communication application 300 of the terminal 100b equipped with extended Echo after device setting processing in the [pattern of setting success] was completed, is shown in FIG. 15.

Firstly, the data flow transmits the communication application 300 of the terminal 100a equipped with extended Echo (step S900), and the QoS processing section 350 of the terminal 100a equipped with extended Echo carries out QoS processing to a data flow, in accordance with “setting information” in which “setting status” of the setting database 340 is “setting” (step S910).

To the data flow which was transmitted from the terminal 100a equipped with extended Echo, the QoS processing section 350 carries out QoS processing in accordance with the setting database 340 of each device, in the same manner as the step S910 of the relay devices 110a, 110b, and 110c equipped with extended Echo (step S920).

Also in the terminal 100b equipped with extended Echo, the QoS processing section 350 carries out QoS of a data flow, in the same manner (step S930), and thereby, the communication application 300 of the terminal 100b equipped with extended Echo can receive a communication quality guaranteed data flow (step S940).

As explained in the [pattern of setting success], since it is possible to carry out device setting processing on a communication route by using extended Echo in this implementation mode, it becomes possible to carry out quality guarantee of data flow as described above.

Pattern of Setting Release

An operation of the device setting system at the time of carrying out a release of a communication quality assurance setting of a data flow specified by the [pattern of setting success] from a status of a device setting after the [pattern of setting success] will be described.

Processing of the terminal 100a equipped with extended Echo, which transmits “setting type” and “setting information” for carrying out a device setting release, will be described.

As to processing in the terminal 100a equipped with extended Echo, parameters of up to judgment processing of “setting type” by the setting judgment section 320 in the step S210 are different from parameters in the [pattern of setting success] in the terminal 100a equipped with extended Echo, and therefore, an explanation will be omitted.

Different parameters are “setting type” and “judgment result”, and the “setting type” is changed to “release”, and the “judgment result” is changed to “no setting release target device”.

In judgment processing of “setting type” in the step S210, since the “setting type” is “release”, it is investigated whether “setting information”, which was specified from the communication application 300, has been registered in the setting database 340 or not (step S220), and since the specified “setting information” has been registered, “judgment result of this device” is set to “setting release success” (step S260), and notified to the setting management section (terminal) 310.

The setting management section (terminal) 310 carries out judgment of “setting type” after “judgment result of this device” was notified thereto (step S120), and investigates whether “judgment result of this device” has been registered in the setting database 340 or not, since “setting type” is “release” (step S130).

As a result of investigation, since “setting information” has been registered, “setting information” is deleted from the setting database 340 (step S140).

After that, the setting management section (terminal) 310 notifies “type of ICMP”, “setting type”, “setting information”, and “judgment result of this device”, to the extended Echo information transmission section 360 (step S150).

Since processing in the extended Echo information processing section 360 in the step S150 is the same as processing of the terminal 100a equipped with extended Echo in the [pattern of setting success], and parameters thereof are simply different, an explanation will be omitted.

Here, a value of each parameter of an extended Echo request message (release) from the extended Echo information transmission section 360 is as shown in (c) of FIG. 3, and data of the setting database 340 has becomes as shown in (a) of FIG. 7.

Next, processing in the relay device 110 equipped with extended Echo at the time that it received the extended Echo request message (release) is shown as follows.

As to processing of the relay device 110a equipped with extended Echo, processing up to judgment processing of an extended Echo message in the setting management section (relay) 380 is the same as processing of the terminal 100a equipped with extended Echo which transmits an extended Echo message (release), and therefore, an explanation will be omitted.

As a result of judgment processing of an extended Echo message in the step S820, since “type of ICMP” is “Echo”, it is judged that it is an extended Echo request message, and furthermore, since “setting type” is “release” (step S840), it is investigated whether “setting information” has been registered in the setting database 340 (step S850). As a result of investigation, since “setting information” has been registered, the “setting information” is deleted from the setting database 340 (step S860). After that, the setting management section (relay) 380 notifies “type of CIMP”, “setting type”, “setting information”, and “judgment result of this device” to the extended Echo information transmission section 360 (step S890), and transmits an extended Echo request message (release).

Since processing of the step S890 is the same as that of the terminal 100a equipped with extended Echo which transmits the extended Echo message (release), an explanation will be omitted. At this time, data of the setting database 340 has become as shown in (a) of FIG. 7.

Since processing of extended Echo corresponding relay devices 10b, 110c at the time that they received an extended Echo request message (release) is the same as that of the relay device 110a equipped with extended Echo which received the extended Echo request message (release), an explanation will be omitted. At this time, all data of the setting databases 340 of respective relay devices equipped with extended Echo have become as shown in (a) of FIG. 7.

Processing of the terminal 100b equipped with extended Echo at the time that it received the extended Echo request message (release) will be described.

Since processing up to processing of changing “type of ICMP” to “Echo-Reply” in the setting management section (terminal) 310 in the step S480 is the same as processing of the relay device 110a equipped with extended Echo at the time that it received the extended Echo request message (release), an explanation will be omitted.

After the step S510, the setting management section (terminal) 310 notifies “type of ICMP”, “setting type”, “setting information”, and “judgment result of this device” to the extended Echo information transmission section 360 (step S490), and transmits an extended Echo reply message (release).

Since processing of the extended Echo information transmission section 360 in the step S490 is the same as that of the extended Echo corresponding terminal 100a which transmits the extended Echo message (release), an explanation will be omitted. At this time, data of the setting database 340 has become as shown in (a) of FIG. 7.

Processing of the relay device 110c equipped with extended Echo, which received an extended Echo reply message (release), will be described.

Since processing up to judgment processing of an extended Echo message in the setting judgment section 320 in the step S200 is the same as processing of the relay device 110a equipped with extended Echo at the time of extended Echo request packet (release) reception, an explanation will be omitted.

In the step S200, since “type of ICMP” is “Echo-Reply”, it is judged that it is an extended Echo reply message, and a value of “judgment result”, which was acquired from an extended Echo message, is copied to “judgment result of this device” (step S250), and notified to the setting management section (relay) 380.

The setting management section (relay 380) carries out extended Echo message type judgment, in the same manner as in the step S200 of the setting judgment section 320, and as a result, it is found that it is an extended Echo reply message (step S820, step S830), and since “setting type” is “release” (step S700), transmission processing of an extended Echo reply message (release) in the extended Echo information transmission section 360 in the step S890 is carried out.

Since processing in the extended Echo information transmission section 360 in the step S890 is the same as processing of the terminal 100b equipped with extended Echo which received an extended Echo request message (release), an explanation will be omitted.

At this time, data of the setting database 340 has become as shown in (a) of FIG. 7.

Since processing of the relay devices 100b and 100a equipped with extended Echo, which received an extended Echo reply message (release), is the same as processing of the relay device 100c equipped with extended Echo which received the extended Echo reply message (release), an explanation will be omitted. At this time, data of the setting database 340 of each of the relay devices 110b and 110a equipped with extended Echo has become as shown in (a) of FIG. 7.

Processing of the terminal 100a equipped with extended Echo at the time that it received the extended Echo reply message (release) will be described. Since processing up to processing of notifying “judgment result of this device” as “judgment result” to the communication application 300 in the step S440 is the same as processing of the relay device 110c extended Echo corresponding which received the extended Echo reply message (release), an explanation will be omitted.

After processing of the step S440 was completed, setting release processing to a device on a communication route is completed.

At this time, since all values of the setting databases 340 of the terminals 100a, 100b equipped with extended Echo, and the relay devices 100a, 100b, 110c equipped with extended Echo have become as shown in (a) of FIG. 7 and deletion of “setting information”, which was specified by the communication application 300, has been carried out, it can be said that unified device settings of the terminal 100 equipped with extended Echo and the relay device 110 equipped with extended Echo on a communication route in the [pattern of setting release] could be carried out. In addition, it is possible to know a judgment result of whether the communication application could be also set up or not.

Pattern of Setting Failure

Processing at the time that a device setting fails after a device setting is carried out from the terminal 100a equipped with extended Echo, in the same manner as the [pattern of setting success], will be shown.

Firstly, statuses of each terminal 100 equipped with extended Echo and each relay device 110 equipped with extended Echo will be shown. Both of the device performance databases 330 of the terminals 100a, 100b equipped with the extended Echo are shown in (b) of FIG. 6, and the device performance databases 330 of the relay devices 110a, 10b, 110c equipped with extended Echo have come into statuses shown in (b) of FIG. 6, (c) of FIG. 6, and (b) of FIG. 6, respectively. In addition, all of the setting databases 340 of the terminals 10a, 100b equipped with extended Echo and the relay devices 100a, 110b, 110c equipped with extended Echo have come into a status shown in (a) of FIG. 7.

A series of device setting processing for carrying out communication quality guarantee of a data flow in the device setting system of FIG. 1 will be shown.

Since processing of transmitting an extended Echo message (setting) in the terminal 100a equipped with extended Echo is the same as processing of the terminal 100a equipped with extended Echo in the [pattern of setting success], an explanation will be omitted.

At this time, a value of each parameter of an extended Echo request message (setting), which is transmitted from the terminal 100a equipped with extended Echo, is as shown in (b) of FIG. 3, and the setting database 340 has come into a status shown in (b) of FIG. 7.

Since processing of the relay device 110a equipped with extended Echo, which received an extended Echo request message (setting), is the same as processing of the relay device 110a equipped with extended Echo in the [pattern of setting success], an explanation will be omitted.

At this time, a value of each parameter of the extended Echo request message (setting), which is transmitted from the relay device 110a equipped with extended Echo, is as shown in (b) of FIG. 3, and the setting data base 340 has come into a status shown in (b) of FIG. 7.

Processing of the relay device 100b equipped with extended Echo, which received the extended Echo request message (setting), will be described.

Since processing up to processing of judging whether setting information can be set up in the setting judgment section 320 in the step S240 is the same as processing of the relay device 110b equipped with extended Echo in the [pattern of setting success], an explanation will be omitted.

In judgment processing of the step S240, “average band width” 25 Mbps of the extended Echo request message (setting) in (b) of FIG. 3 is compared with 20 Mbps of “transmission possible band width” of the device performance database 330 in (c) of FIG. 6, and since “average band width” exceeds “transmission possible band width”, it is judged that it is impossible to set up “setting information”.

Then, in the setting judgment section 320, “setting impossible” is set to “judgment result of this device”, and notified to the setting management section (relay) 380 (step S280).

The setting management section (relay) 380, to which “judgment result of this device” was notified, carries out judgment processing of an extended Echo message (step S820), and since “type of ICMP” is “Echo”, it is judged that it is an extended Echo request message.

After that, since “setting type” is “setting” (step S840), “judgment result of this device” is referred (step S870), and since a value of “judgment result of this device” has become “setting impossible”, transmission processing of an extended Echo request message (setting) in the extended Echo information transmission section 360 in the step S890 is carried out.

At this time, a value of “judgment result of this device” has become “setting impossible”, but since processing in the extended Echo information transmission section 360 in the step S890 is the same as processing of the terminal 100a equipped with extended Echo which received an extended Echo request message (setting), an explanation will be omitted.

A value of each parameter of the extended Echo request message (setting) which is transmitted from the relay device 10b equipped with extended Echo is as shown in (d) of FIG. 3, and the setting database 240 has come into a status shown in (a) of FIG. 7.

Processing of the relay device 110c equipped with extended Echo which received the extended Echo request message (setting) will be described. Since processing up to processing of referring to a value of “judgment result” from the extended Echo request message (setting) in the setting judgment section 320 in the step S230 is the same as processing of the relay device 110c equipped with extended Echo in the [pattern of setting success], an explanation will be omitted.

Since a value of “judgment result” has become “setting impossible” in the step S230, “setting impossible” is set to “judgment result of this device”, and notified to the setting management section (relay) 380 (step S280).

Since subsequent processing after “judgment result of this device” was notified to the setting management section (relay) 380 is the same as processing of the relay device 110b equipped with extended Echo in the [pattern of setting failure], an explanation will be omitted. At this time, a value of each parameter of an extended Echo request message (setting) which is transmitted from the relay device 110c equipped with extended Echo is as shown in (d) of FIG. 3, and the setting database 340 has come into a status shown in (a) of FIG. 7.

Processing of the terminal 100b equipped with extended Echo which received the extended Echo request message (setting) will be described.

Since processing up to processing of changing “type of ICMP” to “Echo-Reply” in the setting management section (terminal) 310 in the step S480 is the same as processing of the relay device 110c equipped with extended Echo at the time that it received the extended Echo request message (setting) in the [pattern of setting failure], an explanation will be omitted.

After that, the setting management section (terminal) 310 notifies “type of ICMP”, “setting type”, “setting information”, and “judgment result of this device” to the extended Echo information transmission section 360, and transmits an extended Echo replymessage (setting) (step S490).

Since processing of the extended Echo information transmission section 360 in the step S490 is the same as that of the terminal 100b equipped with extended which transmits the extended Echo reply message (setting), an explanation will be omitted.

At this time, a value of each parameter of the extended Echo reply message (setting) which is transmitted from the terminal 100b equipped with extended Echo is as shown in (d) of FIG. 3, and the setting database 340 has come into a status shown in (a) of FIG. 7.

Processing of the relay device 110c equipped with extended Echo at the time that it received the extended Echo reply message (setting) will be described.

Since processing up to a step of investigating whether “setting information”, in which “setting status” is “tentative registration”, has been registered in the setting database 340 in the step S710 is the same as processing of the relay device 110c equipped with extended Echo which received the extended Echo replay message (setting) in the [pattern of setting success], an explanation will be omitted.

As a result of investigation in the step S710, since “setting information” has not been registered, the setting management section (relay) 380 notifies “type of ICMP”, “setting type”, “setting information”, and “judgment result of this device”, to the extended Echo information transmission section 360, and transmits an extended Echo reply message (setting) (step S890).

Since processing of the extended Echo information transmission section 360 in the step S890 is the same as that of the terminal 100b equipped with extended Echo which transmits the extended Echo reply message (setting) in the [pattern of setting failure], an explanation will be omitted.

At this time, a value of each parameter of the extended Echo reply message (setting) which is transmitted from the relay device 110c equipped with extended Echo is as shown in (d) of FIG. 3, and the setting database 340 has come into a status shown in (a) of FIG. 7.

Since processing of the relay device 110b equipped with extended Echo which received the extended Echo reply message (setting) is the same as processing of the relay device 110c equipped with extended Echo, an explanation will be omitted.

At this time, a value of each parameter of an extended Echo reply message (setting) which is transmitted from the relay device 110b equipped with extended Echo is as shown in (d) of FIG. 3, and the setting database 340 has come into a status shown in (a) of FIG. 7.

As to processing of the relay device 110a equipped with extended Echo which received the extended Echo reply message (setting) , since processing up to processing of referring to “judgment result of this device” in the setting management section (relay) 380 in the step S720 is the same as processing of the relay device 110a equipped with extended Echo in the [pattern of setting success], an explanation will be omitted. In the step S720, since “judgment result of this device” has become “setting impossible”, deletion of “setting information” from the setting database 340 is carried out (step S740).

After that, the setting management section (relay) 380 notifies “type of CIMP”, “setting type”, “setting information”, and “judgment result of this device” to the extended Echo information transmission section 360, and transmits an extended Echo reply message (setting)(step S890).

Since processing of the extended Echo information transmission section 360 in the step S890 is the same as that of the terminal 100b equipped with extended Echo which transmits the extended Echo reply message (setting) in the [pattern of setting failure], an explanation will be omitted.

At this time, a value of each parameter of the extended Echo replymessage (setting) which is transmitted from the relay device 100a equipped with extended Echo is as shown in (d) of FIG. 3, and the setting database 340 has come into a status shown in (a) of FIG. 7.

Processing of the terminal 100a equipped with extended Echo which received the extended Echo reply message (setting) will be described. Since processing up to processing of notifying “judgment result of this device” as “judgment result”, to the communication application 300 in the step S440 is the same as processing of the relay device 110a equipped with extended Echo which received the extended Echo reply message (setting) in the [pattern of setting failure], an explanation will be omitted. After processing of the step S440 was completed, setting processing to a device on a communication route is completed.

At this time, all values of the setting databases 340 of the terminals 100a, 100b equipped with extended Echo and the relay devices 110a, 110b, 110c equipped with extended Echo have become as shown in (a) of FIG. 7, and it can be said that unified device settings of the terminal 100 equipped with extended Echo and the relay device 110 equipped with Echo corresponding on a communication route in the [pattern of setting failure] could be carried out.

As above, in the device setting system of FIG. 2, flows of device setting processing in the [pattern of setting success], [pattern of setting release], and [pattern of setting failure] were described, and it was shown that unified device settings of the terminal 100 equipped with extended Echo and the relay device 110 equipped with extended Echo on a communication route can be carried out.

Meanwhile, in a setting system using extended Echo, even if each terminal and each relay device, which do not equip to the extended Echo, existed in a mixed manner, there occurs no case to change a payload of an extended Echo message, and therefore, it is possible to carry out a unified device setting in an device equipped with extended Echo.

Meanwhile, in the setting system using extended Echo in this implementation mode, each device equipped with extended Echo has both of the extended Echo information transmission section 370 and the extended Echo information transmission section 360, but it is all right even if it is a device which has only either one of them. In a device which has the extended Echo information transmission section 370, it is possible to acquire information of another device equipped with extended Echo on a communication route, and in a device which has the extended Echo information transmission section 360, it is possible to notify information to another device on a communication route.

Meanwhile, it is also possible to know such information that there exists no device equipped with extended Echo in which “setting information” is setup, by use of a payload of an extended Echo message.

For example, when there exists no device equipped with extended Echo on a communication route at the time that an extended Echo request message (setting) was transmitted, “judgment result” of an extended Echo reply message (setting) becomes “no setting target device”, and therefore, it is possible to know such a fact that an device equipped with extended Echo does not exist on a communication route.

For example, when there exists no device equipped with extended Echo which is holding “setting information” described in a payload, on a communication route at the time that an extended Echo request message (release) was transmitted, “judgment result” of an extended Echo reply message (release) becomes “no setting release target device”, and therefore, it is possible to know such a fact that an device equipped with extended Echo holding “setting information” does not exist on a communication route.

Meanwhile, it may be also used for writing device performance information of the device performance database 430 in a payload of an extended Echo message and for making up device performance information of devices on a communication route.

Meanwhile, in this implementation mode, as a transmission medium for coupling between respective devices, a transmission medium such as wireless and an electric power line by which QoS control can be carried out may be also used.

Meanwhile, in case of RSVP, there was such restriction that a setting starting terminal has to the same as data transmitting terminal, but in the invention, there is such an advantage that there is no restriction as to a setting starting terminal and a data transmitting terminal, and degree for freedom for a setting is high.

Meanwhile, it is possible to substitute an Echo message for, for example, a UDP (User Datagram Protocol) packet in which a destination terminal is addressed to a unused port number, from a setting starting side up to a destination terminal.

In this case, the destination terminal is to transmit an ICMP message in which a type is Destination-Unreachable and a code is Port-Unreachable, but its advantage does not change from the case in which an Echo message was used.

Meanwhile, as the case stands now, there are two versions of IP, i.e., Ipv4 and Ipv6, but since this system is not dependent on a version of IP, its advantage does not change.

Meanwhile, the implementation mode 2 was explained by citing unicast, which is one-to-one communication, as an example, but its advantage does not change even if multicast, which is one-to-multi communication, etc. are used.

Even in case of communicating with an old product which does not correspond to a device setting system and a product which corresponds only to another device setting system, as a communication partner, it is possible to carry out a device setting on a communication route, and therefore, it is possible to carry out a setting of a network device in various situations. In addition, this device setting system can be promising in such a manner that it has a large advantage to such a situation that QOS becomes necessary.

What is claimed is:

1. A communication apparatus, comprising:
an extended Echo information transmission section which transmits an ICMP (Internet Control Message Protocol) message in which information to at least one of a destination terminal for the ICMP message and a relay device on a route to a destination terminal is written in a payload of the ICMP message.

2. A communication apparatus comprising:
an extended Echo information reception section which obtains information to at least one of a destination terminal for an ICMP message and a relay device on a route to a destination terminal, from a payload of the ICMP message.

3. A communication apparatus comprising:
an extended Echo information transmission section which transmits the ICMP message in which information to at least one of a destination terminal for an ICMP (Internet Control Message Protocol) message and a relay device on a route to a destination terminal is written in a payload of the ICMP message, and
an extended Echo information reception section which obtains information to at least one of the a destination terminal for the ICMP (Internet Control Message Protocol) message and the relay device on a route to a destination terminal, from a payload of the ICMP message.

4. The communication apparatus according to claim 1, wherein the ICMP message is at least one of an Echo message, an Echo-Reply message, and a Time-Exceeded message.

5. The communication apparatus according to claim 2, wherein the ICMP message is at least one of an Echo message, an Echo-Reply message, and a Time-Exceeded message.

6. The communication apparatus according to claim 3, wherein the ICMP message is at least one of an Echo message, an Echo-Reply message, and a Time-Exceeded message.

7. The communication apparatus according to claim 1, wherein the information to at least one of a destination terminal for the ICMP message and the relay device on a route to a destination terminal is information regarding QoS (Quality of Service).

8. The communication apparatus according to claim 2, wherein the information to at least one of a destination terminal for the ICMP message and the relay device on a route to a destination terminal is information regarding QoS (Quality of Service).

9. The communication apparatus according to claim 3, wherein the information to at least one of a destination terminal for the ICMP message and the relay device on a route to a destination terminal is information regarding QoS (Quality of Service).

10. The communication apparatus according to claim 2, being equipped with a setting data base which stores the information to at least one of a destination terminal for the ICMP message and the relay device on a route to a destination terminal.

11. The communication apparatus according to claim 3, being equipped with a setting data base which stores the information to at least one of a destination terminal for the ICMP message and the relay device on a route to a destination terminal.

12. The communication apparatus according to claim 2, being equipped with a setting management section which reads out the information to at least one of a destination terminal for the ICMP message and the relay device on a route to a destination terminal, and carries out a setting of QoS of the communication apparatus on the basis of the information.

13. The communication apparatus according to claim 3, being equipped with a setting management section which reads out the information to at least one of a destination terminal for the ICMP message and the relay device on a route to a destination terminal, and carries out a setting of QoS of the communication apparatus on the basis of the information.

14. A communication method for transmitting an ICMP message, and the communication method for transmitting an ICMP message in which information to at least one of a destination terminal for the ICMP message and a relay device on a route to a destination terminal is written in a payload of the ICMP message.

15. A communication method for transmitting an ICMP message, and the communication method for obtaining information to at least one of a destination terminal for an ICMP message and a relay device on a route to a destination terminal, from a payload of the ICMP message.

16. A communication method for transmitting an ICMP message, and the communication method for transmitting an ICMP message in which information to at least one of a destination terminal for the ICMP message and a relay device on a route to a destination terminal is written in a payload of the ICMP message, and for obtaining information to at least one of a destination terminal for an ICMP message and a relay device on a route to a destination terminal, from a payload of the ICMP message.

17. The communication method according to claim 14, wherein the information to at least one of a destination terminal for the ICMP message and the relay device on a route to a destination terminal is information regarding QoS.

18. The communication method according to claim 15, wherein the information to at least one of a destination terminal for the ICMP message and the relay device on a route to a destination terminal is information regarding QoS.

19. The communication method according to claim 16,
wherein the information to at least one of a destination terminal for the ICMP message and the relay device on a route to a destination terminal is information regarding QoS.

20. The communication method according to claim 15, for storing the information to at least one of a destination terminal for the ICMP message and the relay device on a route to a destination terminal.

21. The communication method according to claim 16, for storing the information to at least one of a destination terminal for the ICMP message and the relay device on a route to a destination terminal.

22. The communication method according to claim 15, for carrying out a setting of QoS, on the basis of the information to at least one of a destination terminal for the ICMP message and the relay device on a route to a destination terminal.

23. The communication method as set forth in claim 16, for carrying out a setting of QoS, on the basis of the information to at least one of a destination terminal for the ICMP message and the relay device on a route to a destination terminal.
